(19) United States
(12) Patent Application Publication
(10) Pub. No.: US 2023/0379821 A1
(43) Pub. Date: Nov. 23, 2023

(54) WIRELESS COMMUNICATION SYSTEM, WIRELESS COMMUNICATION METHOD AND TERMINAL DEVICE

(71) Applicant: Nippon Telegraph and Telephone Corporation, Tokyo (JP)

(72) Inventors: Kento Yoshizawa, Musashino-shi, Tokyo (JP); Yosuke Fujino, Musashino-shi, Tokyo (JP); Yohei Katayama, Musashino-shi, Tokyo (JP); Ryo Miyatake, Musashino-shi, Tokyo (JP)

(21) Appl. No.: 18/030,314

(22) PCT Filed: Oct. 15, 2020
(86) PCT No.: PCT/JP2020/038901

§ 371 Date: Apr. 5, 2023

(51) Int. Cl. H04W 52/02

(52) U.S. Cl. CPC H04W 52/0225

(57) ABSTRACT

An aspect of the present invention provides a wireless communication system including: one or more terminal devices that transitions between a first state in which a wireless signal can be intermittently detected and a second state in which a wireless signal can be transmitted and received; and a gateway device that transmits an instruction frame instructing the one or more terminal devices to transition to the second state at a predetermined transmission interval. Each of the one or more terminal devices includes: an instruction frame detector that detects the instruction frame at a detection interval longer than an interval at which the gateway device transmits the instruction frame; a preamble signal detector that detects a preamble signal at a predetermined time interval and a predetermined frequency channel when the instruction frame is detected; and a control unit that causes a subject terminal device to transition from the first state to the second state based on a detection result of one or more preamble signals in one or more frequency channels.

### TECHNICAL FIELD

The present invention relates to techniques for wireless communication systems, wireless communication methods, and terminal devices.

### BACKGROUND ART

IoT (Internet of Things) sensor terminals and the like are often used by being battery-powered, and may be required to have a long life of more than 10 years. In IoT communication, particularly, since the communication request and frequency are relatively low compared to other wireless communications, a method of intermittent communication has been proposed. In particular, it is said that the longer the period of intermittent operation determination, the higher the power saving effect. In connection with this, a method of arbitrarily setting the period of intermittent operation has been studied (see, for example, Patent Literature 1).

FIG. 10 is a timing chart illustrating an operation flow in which a terminal device transitions to an activated state and transmits data in the prior art. First, a gateway device transmits a frame instructing the terminal device to transition to the activated state at a predetermined timing. Hereinafter, this frame is referred to as an “activation instruction frame”, and the instruction to transition to the activated state notified by the activation instruction frame is referred to as an “activation instruction”. The activation instruction frame is composed of a preamble and a payload, and the payload contains identification information of the terminal device to be the target of the activation instruction.

The terminal device attempts to detect the preamble of the activation instruction frame at a predetermined intermittent operation interval T_{DRX}. When the preamble is detected, the terminal device transitions from the intermittent reception state to the activation state. The intermittent reception state is a state in which a wireless signal can be detected, and a frame is not received. On the other hand, the activated state is a state in which frames can be received. The state in which frames can be received is a state in which the received wireless signal can be demodulated to identify the frame and data can be acquired from the frame. The terminal device is in the sleep state except for the timing in which it is in the intermittent reception state and the activation state. The sleep state is a state in which the timing to transition to the intermittent reception state can be detected, the transition to the intermittent reception state can be performed, and data is not transmitted or received. After transitioning to the activation state, the terminal device receives the activation instruction frame and acquires the identification information indicating the target of the activation instruction from the payload. When the terminal device identifies that the target of the activation instruction is the subject device from the acquired identification information, it generates a data frame and transmits it to the gateway device.

FIG. 11 is a timing chart illustrating an operation flow in which a terminal device transitions to the sleep state without transmitting data in the prior art. First, a gateway device transmits an activation instruction frame to the terminal device, and the terminal device detects this activation instruction frame and transitions to the activated state. The operation up to this point is the same as in the case of FIG. 10. After transitioning to the activation state, the terminal device receives the activation instruction frame and acquires the identification information indicating the target of the activation instruction from the payload. In this case, when the terminal device identifies that the target of the activation instruction is not the subject device from the acquired identification information, the terminal device transitions to the sleep state without transmitting data. As shown in FIGS. 11 and 12, the terminal device can suppress power consumption by performing the minimum operations in each of the sleep state, the intermittent reception state, and the activation state. The operation flow shown in FIGS. 11 and 12 can be represented by the flowchart shown in FIG. 13.

### CITATION LIST

### Patent Literature

[PTL 1] Japanese Patent No. 6542959

### SUMMARY OF INVENTION

### Technical Problem

However, in the prior art, all the terminal devices that receive the activation instruction frame are activated from the intermittent reception state and transition to the reception state. Therefore, the power consumption of the terminal device that is not the target of activation has been an issue. Specifically, in the prior art, the intermittent operation can be realized at arbitrary intervals even if the number of terminal devices increases. However, when each terminal device succeeds in detecting an activation instruction frame, it transitions from an intermittent reception state to an activated state and can receive and demodulate wireless frames. Here, the detection of the activation instruction frame is based on preamble detection, peak detection, and the like, and it cannot be determined whether it is the activation target until the contents of the payload are confirmed. Therefore, each terminal device needs to receive the activation frame and confirm the contents of the payload regardless of whether the subject device is the activation target, and the power required for executing those processes is consumed by each device.

In view of the above circumstances, an object of the present invention is to provide a technique capable of reducing the power consumption of a terminal device that performs wireless communication by an intermittent operation.

### Solution to Problem

An aspect of the present invention provides a wireless communication system including: one or more terminal devices that transitions between a first state in which a wireless signal can be intermittently detected and a second state in which a wireless signal can be transmitted and received; and a gateway device that transmits an instruction frame instructing the one or more terminal devices to transition to the second state at a predetermined transmission interval, wherein each of the one or more terminal devices includes: an instruction frame detector that detects the instruction frame at a detection interval longer than an interval at which the gateway device transmits the instruction frame; a preamble signal detector that detects a preamble signal at a predetermined time interval and a predetermined frequency channel when the instruction frame is detected; and a control unit that causes a subject terminal device to transition from the first state to the second state based on a detection result of one or more preamble signals in one or more frequency channels.

Another aspect of the present invention provides a wireless communication method in a wireless communication system including: one or more terminal devices that transitions between a first state in which a wireless signal can be intermittently detected and a second state in which a wireless signal can be transmitted and received; and a gateway device that transmits an instruction frame instructing the one or more terminal devices to transition to the second state at a predetermined transmission interval, wherein each of the one or more terminal devices executes: an instruction frame detection step of detecting the instruction frame at a detection interval longer than an interval at which the gateway device transmits the instruction frame; a preamble signal detection step of detecting a preamble signal at a predetermined time interval and a predetermined frequency channel when the instruction frame is detected; and a control step of causing a subject terminal device to transition from the first state to the second state based on a detection result of one or more preamble signals in one or more frequency channels.

Another aspect of the present invention provides a terminal device in a wireless communication system including: one or more terminal devices that transitions between a first state in which a wireless signal can be intermittently detected and a second state in which a wireless signal can be transmitted and received; and a gateway device that transmits an instruction frame instructing the one or more terminal devices to transition to the second state at a predetermined transmission interval, each of the terminal devices including: an instruction frame detector that detects the instruction frame at a detection interval longer than an interval at which the gateway device transmits the instruction frame; a preamble signal detector that detects a preamble signal at a predetermined time interval and a predetermined frequency channel when the instruction frame is detected; and a control unit that causes a subject terminal device to transition from the first state to the second state based on a detection result of one or more preamble signals in one or more frequency channels.

### Advantageous Effects of Invention

According to the present invention, it is possible to reduce the power consumption of a terminal device that performs wireless communication by an intermittent operation.

### BRIEF DESCRIPTION OF DRAWINGS

FIG. 1 is a diagram showing a system configuration example of a wireless communication system of an embodiment.

FIG. 2 is a flowchart showing an example of a process in which a terminal device of the embodiment controls a state transition of the subject device.

FIG. 3 is a diagram showing a first operation example by the wireless communication system of the embodiment.

FIG. 4 is a diagram showing a second operation example by the wireless communication system of the embodiment.

FIG. 5 is a diagram showing a third operation example by the wireless communication system of the embodiment.

FIG. 6 is a diagram showing a fourth operation example by the wireless communication system of the embodiment.

FIG. 7 is a diagram showing a fifth operation example by the wireless communication system of the embodiment.

FIG. 8 is a diagram showing a first modified example of the wireless communication system of the embodiment.

FIG. 9 is a diagram showing a second modified example of the wireless communication system of the embodiment.

FIG. 10 is a timing chart illustrating an operation flow in which a terminal device transitions to an activated state and transmits data in the prior art.

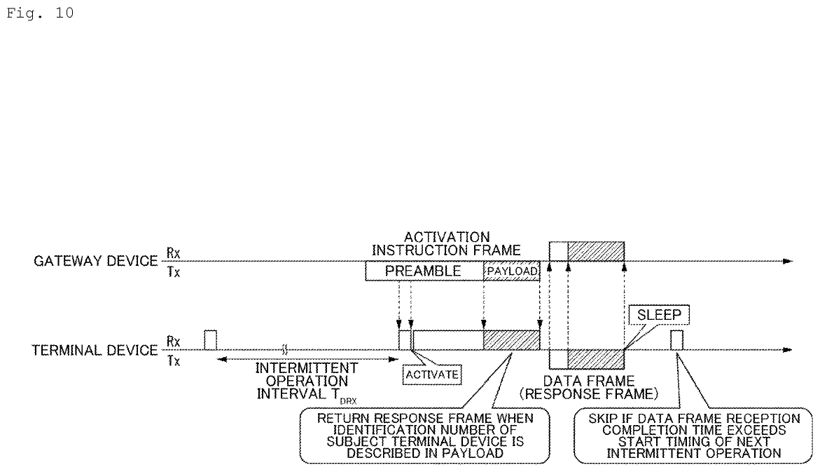

FIG. 11 is a timing chart illustrating an operation flow in which a terminal device transitions to a sleep state without transmitting data in the prior art.

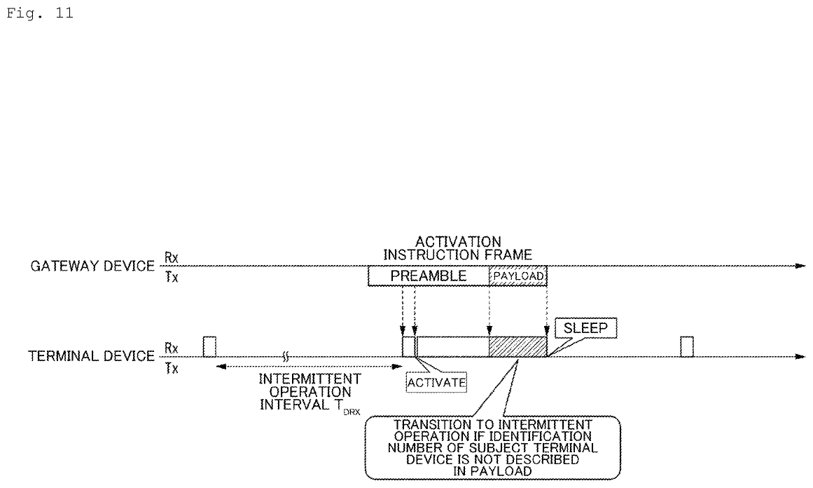

FIG. 12 is a flowchart showing an operation flow in which a terminal device controls a state transition of the subject device in the prior art.

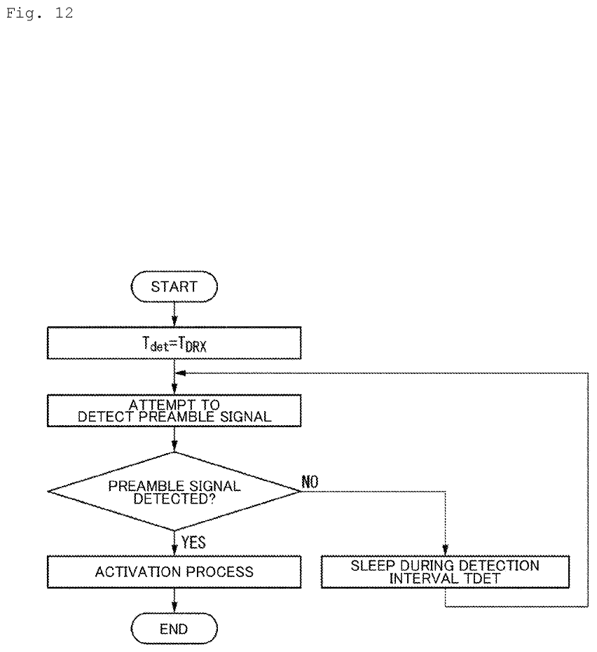

### DESCRIPTION OF EMBODIMENTS

Embodiments of the present invention will be described in detail with reference to the drawings.

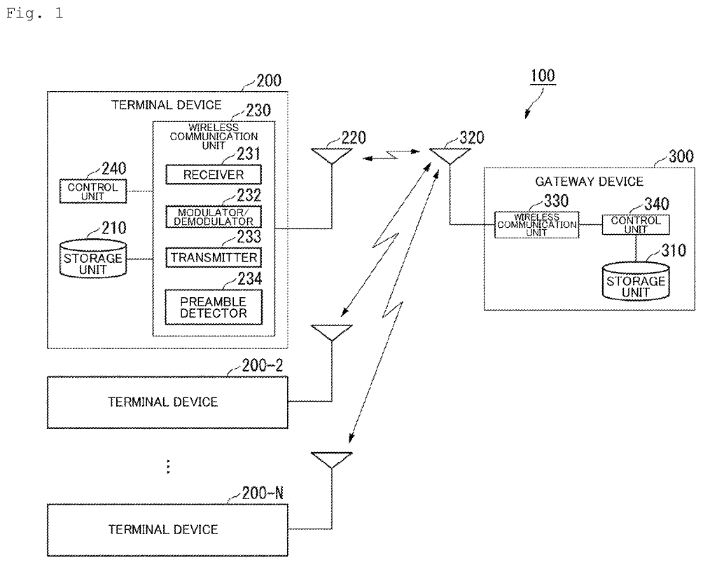

FIG. 1 is a diagram showing a system configuration example of a wireless communication system 100 of the embodiment. The wireless communication system 100 includes terminal devices 200-1 to 200-N (N is an integer of 1 or more) and a gateway device 300. The terminal device 200 and the gateway device 300 each have an antenna for transmitting and receiving a wireless signal, and are connected to each other via the respective antennas so as to be able to wirelessly communicate with each other. In the following, unless otherwise specified, the terminal devices 200-1 to 200-N will be referred to as the terminal devices 200.

The terminal device 200 includes a CPU (Central Processing Unit), a memory, an auxiliary storage device, and the like connected by a bus, and executes a program. The terminal device 200 functions as a device including a storage unit 210, a radio antenna 220, a wireless communication unit 230, and a control unit 240 by executing a program. All or part of the functions of the terminal device 200 may be realized by using hardware such as an ASIC (Application Specific Integrated Circuit), a PLD (Programmable Logic Device), or an FPGA (Field Programmable Gate Array). A program may be recorded in a computer-readable recording medium. The computer-readable recording medium is, for example, a portable medium such as a flexible disk, a magneto-optical disk, a ROM, or a CD-ROM, or a storage device such as a hard disk built in a computer system. The program may be transmitted via an electrical communication line.

The storage unit 210 is configured by using a storage device such as a magnetic storage device or a semiconductor storage device. The storage unit 210 may be a RAM (Random Access Memory) or a rewritable ROM (Read Only Memory) such as a flash memory. The storage unit 210 stores various pieces of data necessary for the operation of the terminal device 200.

The radio antenna 220 is a device that converts an input electric signal into a radio wave and outputs it, and also receives a radio wave and converts it into an electric signal. Specifically, the radio antenna 220 converts an electrical signal for transmission output from the wireless communication unit 230 into a radio wave and outputs the radio wave. The radio antenna 220 converts the received radio wave into an electric signal, and outputs the electric signal obtained by the conversion to the wireless communication unit 230 as a received signal.

The wireless communication unit 230 has a function of transmitting and receiving target data to and from the gateway device 300 via the radio antenna 220. Specifically, the wireless communication unit 230 includes a transmitter 231, a modulator/demodulator 232, a receiver 233, and a preamble detector 234.

The transmitter 231 has a function of transmitting data to be transmitted (hereinafter referred to as “target data”) to the gateway device 300. Specifically, the transmitter 231 acquires the target data and generates a frame for transmitting the acquired target data. The transmitter 231 outputs the generated frame to the modulator/demodulator 232.

The modulator/demodulator 232 modulates the frame output from the transmitter 231 to generate a transmission signal, and up-converts the generated transmission signal to the frequency band of radio transmission and outputs the signal to the radio antenna 220. The modulator/demodulator 232 restores the frame by down-converting and demodulating the received signal input from the radio antenna 220, and outputs the restored frame to the receiving unit 233.

The receiving unit 233 has a function of acquiring the target data transmitted by the gateway device 300 to the terminal device 200. Specifically, the receiving unit 233 acquires the frame restored by demodulating the wireless signal from the modulator/demodulator 232, and acquires the target data from the acquired frame. The target data transmitted and received by the terminal device 200 is not limited to specific data, and may be arbitrary data.

The preamble detector 234 has a function of detecting the preamble signals of the activation instruction frame and the ID notification frame from the wireless signal (hereinafter referred to as “received signal”) received via the radio antenna 220. For example, this detection function may be realized by a CAD (Channel Activity Detection) function in a conventional LoRa modulation method (an example of a communication method using a chirp spread modulation method). The activation instruction frame is a frame for instructing the terminal device 200 to transition to the activation state, and the ID notification frame is a frame for notifying an ID signal described later.

Specifically, the preamble detector 234 detects the preamble signal at a predetermined time interval T_{det} (hereinafter referred to as “detection interval”). For example, the preamble detector 234 detects the preamble signal by comparing the received signal with a preset signal pattern. The signal pattern to be compared with the received signal may be stored in the storage unit 210, for example. The preamble detector 234 notifies the control unit 240 of the detection result of the preamble signal.

The control unit 240 has a function of controlling the operating state of the terminal device 200. Specifically, the terminal device 200 makes a state transition between a sleep state, an intermittent reception state, and an activation state. The sleep state is a state in which the terminal device 200 does not transmit or receive a wireless signal. The intermittent reception state is a state in which the preamble of the activation instruction frame transmitted by the gateway device 300 can be detected. The terminal device 200 in the sleep state transitions to the intermittent reception state at the detection interval T_{det}. In the intermittent reception state, the terminal device 200 only detects the preamble of the activation instruction frame, and does not perform a frame reception process (including demodulation). In addition, the activated state is a state in which at least reception of frames can be performed among transmission and reception. The details of the method in which the control unit 240 controls the state transition will be described later.

Next, the configuration of the gateway device 300 will be described. The gateway device 300 includes a CPU, a memory, an auxiliary storage device, and the like connected by a bus, and executes a program. The gateway device 300 functions as a device including a storage unit 310, a radio antenna 320, a wireless communication unit 330, and a control unit 340 by executing a program. In addition, all or part of the functions of the gateway device 300 may be realized by using hardware such as ASIC, PLD and FPGA. A program may be recorded in a computer-readable recording medium. The computer-readable recording medium is, for example, a portable medium such as a flexible disk, a magneto-optical disk, a ROM, or a CD-ROM, or a storage device such as a hard disk built in a computer system. The program may be transmitted via an electrical communication line.

The storage unit 310 is configured by using a storage device such as a magnetic storage device or a semiconductor storage device. The storage unit 310 may be a RAM or a rewritable ROM such as a flash memory. The storage unit 310 stores various pieces of data necessary for the operation of the gateway device 300.

The radio antenna 320 is a device that converts an input electric signal into a radio wave and outputs it, and also receives a radio wave and converts it into an electric signal. Specifically, the radio antenna 320 converts an electrical signal for transmission output from the wireless communication unit 330 into a radio wave and outputs the radio wave. The radio antenna 320 converts the received radio wave into an electric signal, and outputs the electric signal obtained by the conversion to the wireless communication unit 330 as a received signal.

The wireless communication unit 330 has a function of transmitting and receiving target data to and from the terminal device 200 via the radio antenna 320. Specifically, the wireless communication unit 330 modulates the target data output from the control unit 340 to generate a transmission signal, and up-converts the generated transmission signal to the frequency band for wireless transmission and outputs the signal to the radio antenna 320. The wireless communication unit 330 restores the frame by down-converting and demodulating the received signal input from the radio antenna 320, and outputs the restored frame to the control unit 340.

The control unit 340 has a function of controlling the operating state of the terminal device 200. Specifically, the control unit 340 transmits an activation instruction frame to the terminal device 200 at a predetermined time interval T_{BCN} (hereinafter referred to as “transmission interval”), and also transmits an ID transmission frame during the transmission interval T_{BCN} to control the operating state of the terminal device 200. The activation instruction frame is a frame having a payload containing information about the activation instruction and a preamble indicating that it is an activation instruction frame. The ID transmission frame is a frame in which the preamble contains information for causing the terminal device 200 to identify the target of the activation instruction. The control unit 340 outputs the generated activation instruction frame and ID transmission frame to the wireless communication unit 330. The transmission interval T_{BCN} is a fixed value determined based on the system design.

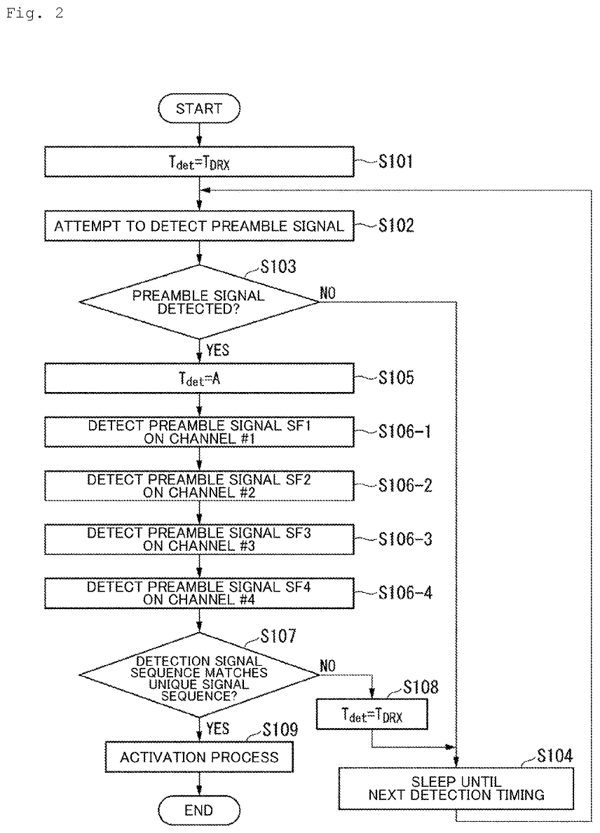

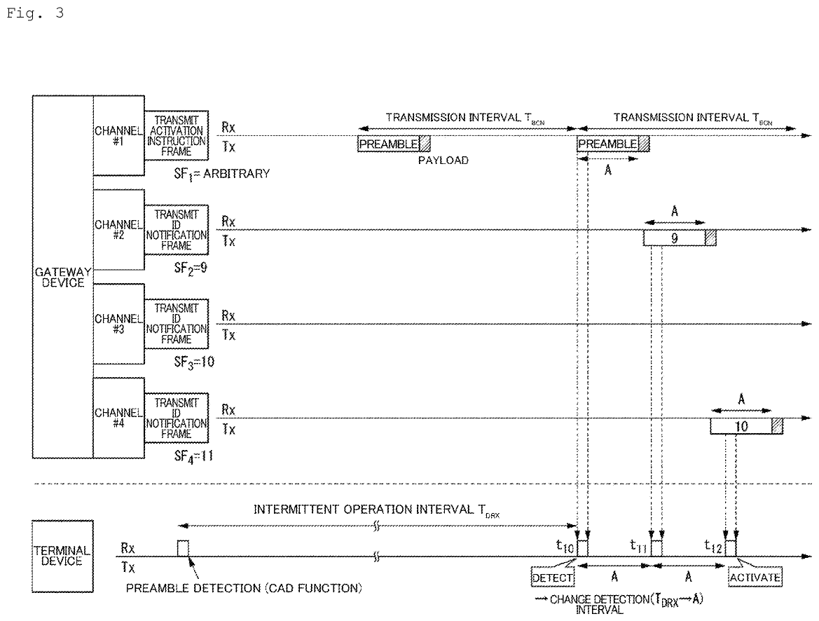

FIG. 2 is a flowchart showing an example of a process in which the terminal device 200 of the embodiment controls the state transition of the subject device. FIG. 3 is a diagram showing a first operation example by the wireless communication system 100 of the embodiment. Hereinafter, the processing flow of the flowchart of FIG. 2 will be described with reference to the operation example of FIG. 3 as appropriate.

First, the control unit 240 sets the detection interval T_{det} to a time T_{DRX} longer than the interval T_{BCN} at which the gateway device 300 transmits the activation instruction frame (step S101). Here, T_{DRX} is a fixed value determined based on the system design, similarly to the transmission interval T_{BCN}. For example, T_{DRX} and T_{BCN} can be determined by the method described in Patent Literature 1.

Subsequently, the preamble detector 234 attempts to detect the preamble signal of the activation instruction frame in a predetermined frequency channel (hereinafter, simply referred to as “channel”) (step S102). For example, in the operation example of FIG. 3, the preamble detector 234 detects the preamble signal on channel #1.

Subsequently, the control unit 240 determines in step S102 whether the preamble signal of the activation instruction frame is detected (step S103). Here, when it is determined that the preamble signal of the activation instruction frame is not detected (step S103: NO), the control unit 240 sleeps until the next timing of attempting to detect the activation instruction frame (step S104), and then the process returns to S102. More specifically, the control unit 240 puts the subject device into the sleep state for a time obtained by subtracting the time required for the detection process (for example, the time required for executing steps S102 and S103) from the detection interval T_{det} (=T_{DRX}), and then returns the subject device to the intermittent reception state again, and the process returns to step S102. As a result, step S102 is executed at each detection interval T_{DRX}.

On the other hand, when it is determined that the preamble signal of the activation instruction frame is detected (step S103: YES), the control unit 240 changes the detection interval T_{det} to a time shorter than the transmission interval T_{BCN} of the activation instruction frame (step S105). For example, in the operation example of FIG. 3, the preamble detector 234 changes the detection interval T_{det} to an interval A shorter than the transmission interval T_{BCN} of the activation instruction frame by detecting the preamble signal of the activation instruction frame transmitted at time t₁₀. For example, the interval A can be determined based on the air time according to the preamble signal length of the activation instruction frame.

Subsequently, the preamble detector 234 attempts to detect the preamble signal corresponding to each channel in a predetermined order for one or more channels (step S106). For example, in the examples of FIGS. 2 and 3, the preamble detector 234 detects channels #1, #2, #3, and #4 in this order, and detects preamble signals SF₂ and SF₄ in channels #2 and #4, respectively (steps S106-1 to S106-4). The preamble detector 234 notifies the control unit 240 of the detection result of the preamble signal.

Here, the gateway device 300 stores in advance the preamble signal to be transmitted according to the order of the channels in which the terminal device 200 detects the preamble signal (hereinafter referred to as “detection order”), and transmits the ID notification frame including the signal SFₖ according to the channel in the preamble signal in a predetermined detection order. Hereinafter, the signal SFₖ notified by the preamble signal of the ID notification frame is referred to as an “ID signal”. k is an integer of 1 or more and represents a channel identification number. That is, SFₖ represents an ID notification frame transmitted from the k-th channel. For example, a spreading factor value (SF value: Spreading Factor) may be used for the ID signal.

The SF value is an example of a value that can be used as an ID signal, and the ID signal is not limited to this. Any value may be used for the ID signal as long as it is a value that can form a unique signal sequence described later. For example, for the ID signal, other parameters related to the wireless communication method may be used, or a predetermined value may be used. The wireless communication method may be a method other than the frequency spread method.

In the operation example of FIG. 3, the gateway device 300 transmits an ID notification frame for notifying SF₂=9 on channel #2, and transmits an ID notification frame for notifying SF₄=10 on channel #4. The ID notification frame can be detected by a terminal device 200 other than the terminal device 200 that is the target of the activation instruction.

Subsequently, the control unit 240 determines whether a signal sequence represented by the preamble signal detected in step S106 (hereinafter referred to as “detection signal sequence”) matches a unique signal sequence stored in advance in the subject device (hereinafter referred to as “unique signal sequence”) (step S107). For example, in the example of FIG. 3, the signal sequence “910” in which the detected preamble signals are arranged in the detection order (that is, the order of SF₂ and SF₄) is set as the detection signal sequence, and it is determined whether this signal sequence matches the unique signal sequence of the subject device.

Here, when it is determined that the detection signal sequence does not match the unique signal sequence (step S107: NO), the control unit 240 returns the detection interval T_{det} to T_{DRX} longer than the transmission interval T_{BCN} (step S108), and then the process proceeds to S104. On the other hand, when it is determined that the detection signal sequence matches the unique signal sequence (step S107: YES), the control unit 240 executes an activation process for transitioning the subject device from the intermittent reception state to the activation state (step S109). For example, the control unit 240 transitions the modulator/demodulator 232 and the receiver 233 from an inoperable state to an operable state. For example, the transition from the inoperable state to the operable state may be a transition from a power-off state to a power-on state, or a transition from a program non-execution state to an execution state. In addition to the modulator/demodulator 232 and the receiver 233, the control unit 240 may transition the transmitter 231 from the inoperable state to the operable state.

For example, the operation example of FIG. 3 shows a case where the determination result in step S107 is true (YES). That is, in this case, the unique signal sequence “910” is registered in advance in the terminal device 200, and the activation process is executed at time t₁₁ because it is determined that it matches the detection signal sequence “910”.

In the flowchart of FIG. 2, the case where the terminal device 200 attempts to detect the ID notification frame for all channels has been described. However, the control unit 240 may be configured such that, each time the preamble signal of the ID notification frame is detected, the detection signal sequence and the unique signal sequence are compared with each other, and when it is determined by the preamble signal that has already been detected that the subject device is the target of the activation instruction, the detection of the subsequent ID notification frame may be omitted. In this case, for example, in the example of FIG. 2, when the detection signal sequence by the preamble signal detected in steps S106-1 to S106-3 matches the unique signal sequence, the control unit 240 may omit the execution of step S106-4.

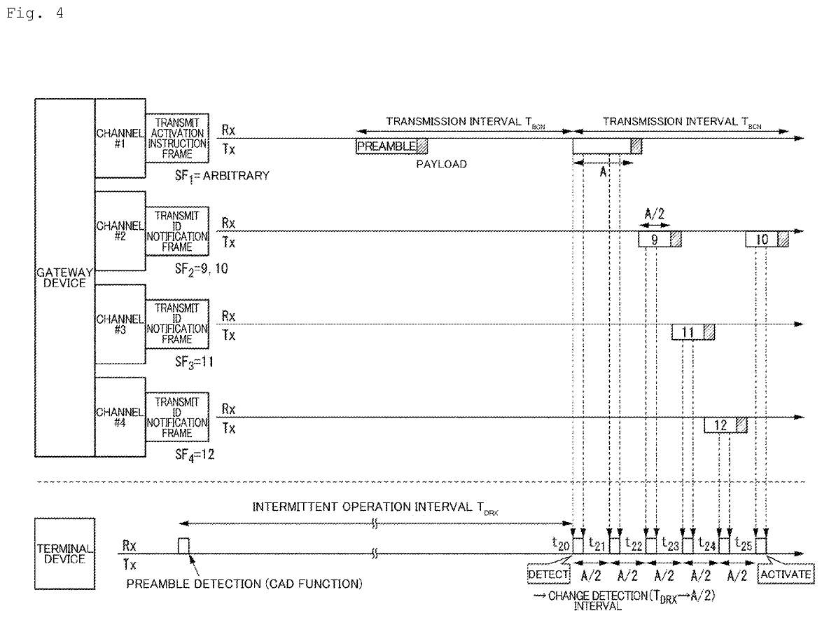

FIG. 4 is a diagram showing a second operation example by the wireless communication system 100 of the embodiment. The second operation example is different from the first operation example mainly in the following points (1) to (3).

(1) In step S105 of the flowchart of FIG. 2, the detection interval T_{det} is set to half (A/2) of A in the example of FIG. 3.

(2) The detection order of the ID signal is channel #2, channel #3, channel #4, and channel #2.

(3) SF₁=arbitrary, SF₂=9, 10 (meaning that 10 is transmitted after 9), SF₃=11, and SF₄=12.

As described above, for the ID notification frame, the variation of the pattern of the detection signal sequence can be increased by shortening the detection interval of the preamble signal. Therefore, according to the second operation example, the number of terminal devices 200 for executing the intermittent operation can be increased as needed.

When the detection interval of the ID notification frame is shorter than the preamble signal length A of the activation instruction frame (A/2 in the example of the figure) as in the example of FIG. 4, the preamble signal of the activation instruction frame may be detected multiple times. For example, in FIG. 4, the preamble signal of the same activation instruction frame is detected at times t₂₀ and t₂₁. In this way, when the activation instruction frame is detected a plurality of times during one transmission interval T_{BCN}, the control unit 240 may ignore the second and subsequent detections, or compare the detection signal sequence and the unique signal sequence on condition that the activation instruction frame is detected a plurality of times.

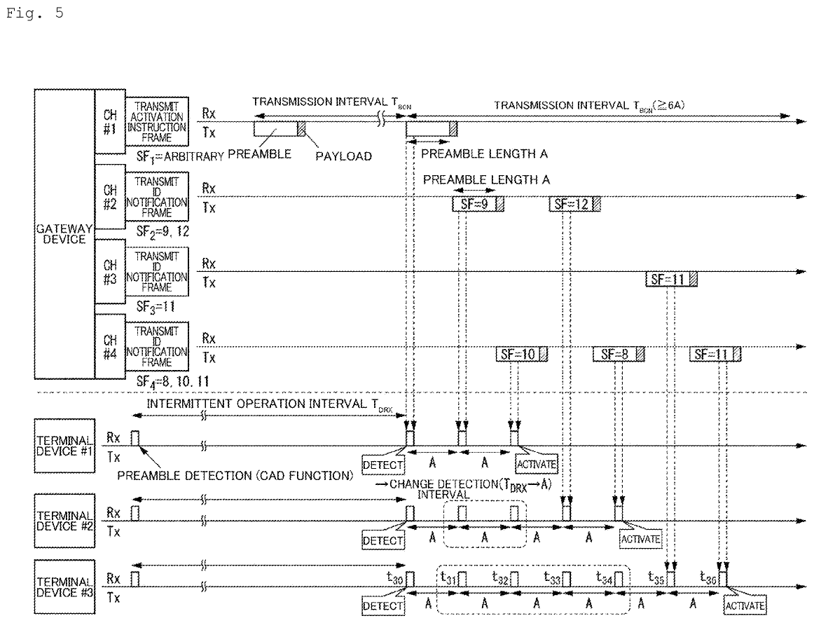

FIG. 5 is a diagram showing a third operation example by the wireless communication system 100 of the embodiment. The third operation example is different from the first operation example in that each of the plurality of terminal devices 200 determines whether the target of the activation instruction is the subject device. However, the operation of each terminal device 200 is the same as the operation of the terminal device 200 in the first operation example.

In the third operation example, the first terminal device 200 (hereinafter, the n-th terminal device 200 is referred to as “terminal device #n”, where n is an integer of 1 to 4) detects the preamble signal of the activation instruction frame transmitted at time t₃₀. After that, since the detection signal sequence “910” by the preamble signals detected in the order of channels #2 and #4 matches the unique signal sequence, it is determined to execute the activation process in response to detection of the preamble signal at time t₃₀+2A.

In the third operation example, the terminal device #2 detects the preamble signal of the activation instruction frame transmitted at time t₃₀. After that, since the detection signal sequence “128” by the preamble signal detected on the channel #2 at time t₃₃ and the preamble signal detected on the channel $4 at time t₃₄ match the unique signal sequence, it is determined to execute the activation process in response to the detection of the preamble signal at time t₃₀+4A.

Similarly, in the third operation example, the terminal device #3 detects the preamble signal of the activation instruction frame transmitted at time t₃₀. After that, since the detection signal sequence “1111” by the preamble signal detected on the channel #3 at time tis and the preamble signal detected on the channel #4 at time t₃₆ match the unique signal sequence, it is determined to execute the activation process in response to the detection of the preamble signal at time t₃₀+6A.

In the third operation example, since the unique signal sequence of one terminal device 200 is represented by two ID signals, when an activation instruction is given to three terminal devices 200 during one transmission interval T_{BCN}, it is necessary to transmit a set of ID notification frames (hereinafter referred to as “ID notification frame set”) required for representing the unique signal sequence of one terminal device 200 for three units during the transmission interval T_{BCN}. For example, in the example of FIG. 5, an ID notification frame set composed of two ID notification frames is transmitted for three units. Therefore, the transmission interval T_{BCN} in this case needs to be set to a time longer than at least 6A (=2A×3).

The gateway device 300 may be configured to transmit an ID notification frame so that one terminal device 200 detects the ID notification frame set for which the terminal device 200 is the target of the activation instruction a plurality of times. For example, when an ID notification frame set for which one terminal device 200 is the target of the activation instruction is composed of two ID notification frames, and one terminal device 200 detects an ID notification frame set three times during one transmission interval T_{BCN}, the transmission interval T_{BCN} needs to be set to a time longer than at least 6A (=2A×3).

According to such a configuration, the unique signal sequence can be represented by the preamble signals detected for a plurality of ID notification frame sets, so that the number of variations of the unique signal sequence can be increased even when the number of channels and the number of SF value patterns are small. Further, the terminal device 200 can be configured to transition to the activation state when the match between the unique signal sequence and the detection signal sequence is determined a plurality of times, and the terminal device that is not the target of the activation instruction can be suppressed from transitioning to the activated state due to a coincidence.

The comparison between the unique signal sequence and the detection signal sequence is an example of a means for causing each terminal device 200 to identify whether it is the target of the activation instruction, and the means may be implemented by other methods as long as each terminal device 200 can identify an event unique to itself. In that sense, the presence/absence of detection of the ID notification frame or the pattern of presence/absence of detection can also be a means for representing an event unique to each terminal device 200. For example, when the event that the ID notification frame is detected is represented by “o” and the event that the ID notification frame is not detected is represented by “x”, the event unique to a certain terminal device 200 can be represented by a combination of the events of “o” and “x”. In this case, the terminal device 200 can be configured to transition to the activated state when the events of “o” and “x” are continuous in a predetermined pattern. For example, in the example of FIG. 5, if the condition for transitioning the terminal device #2 to the activated state is “xxO”, the terminal device #2 determines to execute the activation process at time t₃₃. If such a detection pattern is determined in advance according to the channel used by each terminal device 200, it is possible to cause a specific terminal device 200 to transition to the activated state by the gateway device 300 transmitting an ID notification frame so that the specific terminal device 200 detects the ID notification frame in a specific pattern. In this case, the events of “o” and “x” may be defined by not only whether the ID notification frame is detected, but also by the combination of the channels in which the ID notification frame is detected and the values of the detected ID signals. That is, in the terminal device 200 of the present embodiment, the control unit 240 is configured to transition the subject terminal device from the sleep state to the activated state based on the detection result of the preamble signal of one or more ID notification frames in one or more frequency channels.

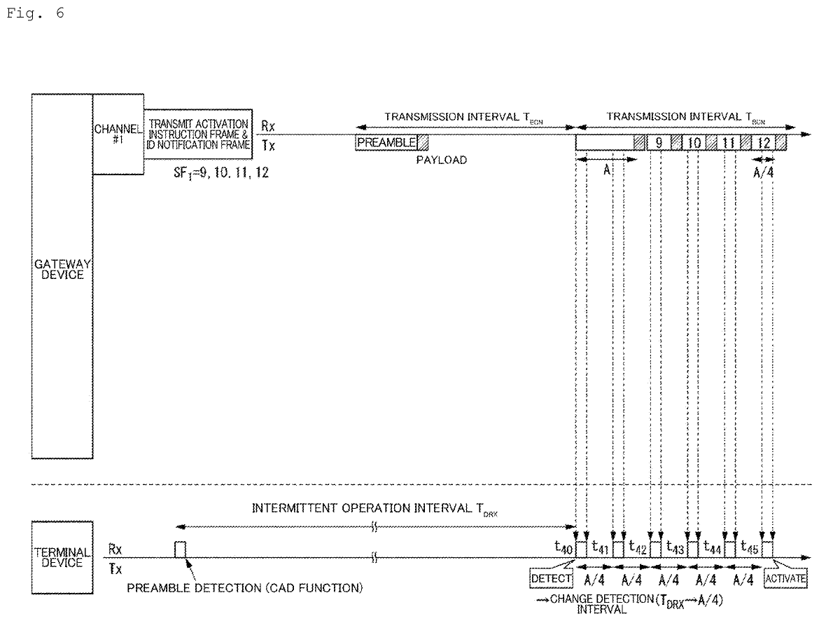

FIG. 6 is a diagram showing a fourth operation example by the wireless communication system 100 of the embodiment. The fourth operation example is different from the first operation example in the following points (1) to (3).

(1) The gateway device 300 transmits both the activation instruction frame and the ID notification frame on one channel (channel #1 in this case).

(2) In step S105 of the flowchart of FIG. 2, the detection interval T_{det} is set to a quarter (A/4) of A in the example of FIG. 3.

(3) SF₁=9, 10, 11, and 12.

In this case, in step S106 of the flowchart of FIG. 2, the terminal device 200 generates a detection signal sequence based on the preamble signal detected on channel #1, but the basic processing flow is the same as that of the flowchart of FIG. 2.

In the fourth operation example, the terminal device 200 detects the preamble signal of the activation instruction frame transmitted at time t₄₀ (or t₄₁). After that, since the detection signal sequence “9101112” by the preamble signals detected at time t₄₂, t₄₃, t₄₄, and t₄₅ matches the unique signal sequence, it is determined to execute the activation process in response to the detection of the preamble signal at time t₄₅=t₄₀+5A/4.

In the spectrum spread communication, signals having different SF values can be completely separated and handled, so that signals having a plurality of SF values can be transmitted simultaneously on a single channel. Therefore, when the SF value is used as the ID signal and a plurality of different ID signals are notified by a single channel, each ID notification frame may be transmitted in a time division manner as shown in FIG. 6, or may be transmitted at the same time by utilizing the separability of the spectrum spread method.

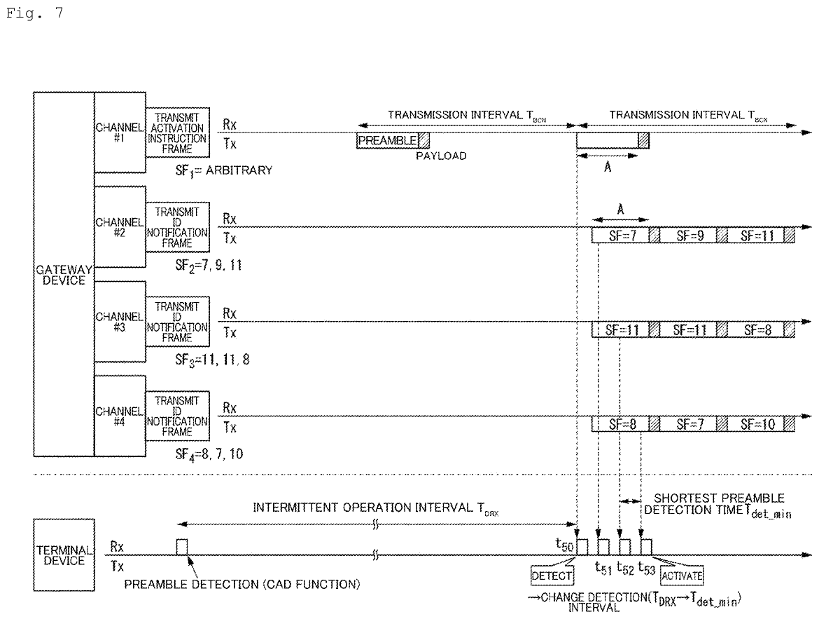

FIG. 7 is a diagram showing a fifth operation example by the wireless communication system 100 of the embodiment. The fifth operation example is different from the first operation example in the following points (1) to (4).

(1) The gateway device 300 transmits an activation instruction frame on a specific channel (in this example, channel #1), and transmits an ID notification frame on the other channels (in this example, channel #2, channel #3, and channel #4).

(2) The gateway device 300 transmits an ID notification frame so that a unique signal sequence is composed of ID signals detected in one detection interval.

(3) The detection interval of the ID notification frame is set to the shortest time T_{det_min} (hereinafter referred to as “shortest detection interval”) required for detecting the preamble signal of the ID notification frame. The detection interval does not necessarily have to be the shortest detection time itself, and may be a time including an allowable margin based on the shortest detection time.

(4) SF₁=arbitrary, SF₂=7 and 9, and 10, SF₃=11, 11, and 8, and SF₄=8, 7, and 10.

For example, in the operation example of FIG. 7, the gateway device 300 transmits an activation instruction frame on channel #1 at each transmission interval T_{BCN}, and in response to the transmission of each activation instruction frame, transmits the ID signals forming one unique signal sequence on the other channels #2, channel #3, and channel #4 during the time T_{BCN} until the next activation instruction frame is transmitted. In the operation example of FIG. 7, the gateway device 300 continuously transmits the ID notification frame for transmitting the ID signal as described above in each channel. Specifically, the gateway device 300 continuously transmits the ID notification frames at intervals A based on the activation instruction frame length in the order of SF₂=7, 9, and 11 for channel #2, SF₃=11, 11, and 8 for channel #3, and SF₄=8, 7, and 10 for channel #4.

In this case, for example, the terminal device 200 detects the preamble signal of the activation instruction frame at time t₅₀, changes the detection interval to the shortest detection interval T_{det_min}, and detects the preamble signal of the ID notification frame. For example, in the operation example of FIG. 7, the terminal device 200 detects the preamble signal on channel #2 at time t₅₁, detects the preamble signal on channel #3 at time t₅₂, and detects the preamble signal on channel #4 at time t₅₃. In this case, the terminal device 200 determines to execute the activation process in response to the detection of the preamble signal at time t₅₃=t₅₀+3T_{det_min} since the detection signal sequence “7118” by the preamble signals detected at times t₅₁, t₅₂, and t₅₃ matches the unique signal sequence.

With such a configuration, the terminal device 200 can identify whether the subject device is the target of the activation instruction in a shorter time.

In the wireless communication system 100 of the embodiment configured as described above, the gateway device 300 transmits an activation instruction frame and an ID notification frame at a predetermined transmission interval, and the terminal device 200 that attempts to detect the activation instruction frame at a predetermined detection interval changes the detection interval and attempts to detect the ID notification frame when the activation instruction frame is detected. Then, the terminal device 200 transitions to the activated state when the detection signal sequence represented by the detected ID signal matches the unique signal sequence of the subject device. According to the wireless communication system 100 of the embodiment having such a configuration, when the activation instruction frame is detected, the terminal device 200 can identify whether the activation instruction frame instructs the subject device to transition to the activated state by detecting the preamble signal.

Conventionally, the terminal device that has detected the activation instruction frame once transitions to the activation state and receives the activation instruction frame to determine whether the target of the activation instruction is the subject device. On the other hand, the terminal device 200 of the embodiment can determine whether the target of the activation instruction is the subject device in the intermittent reception state without transitioning to the activated state. Therefore, according to the wireless communication system 100 of the embodiment, it is possible to reduce the power consumption of the terminal device 200 that performs wireless communication by an intermittent operation.

In the above embodiment, the case where the preamble detector 234 detects the activation instruction frame and the ID notification frame has been described. For example, the preamble detector 234 is an example of an instruction frame detector and a preamble signal detector in the present invention. However, the activation instruction frame detection function and the ID notification frame detection function of the preamble detector 234 may be realized as separate functional units. In the above embodiment, the case where the terminal device 200 detects the preamble signal by changing the interval of the intermittent operation from the interval for detecting the activation instruction frame to the interval for detecting the ID notification frame has been described. However, the interval for detecting the activation instruction frame and the interval for detecting the ID notification frame may be defined as different parameters.

In the above embodiment, both the operation state for detecting the ID notification frame and the operation state for detecting the activation instruction frame are defined as the intermittent reception state. However, the operation state for detecting the ID notification frame may be defined as an operation state different from the intermittent reception state (hereinafter, referred to as “ID frame detection state”). In this case, the process of transitioning from the intermittent reception state to the ID frame detection state may be referred to as a first activation process, and the process of transitioning from the ID frame detection state to the activation state may be referred to as a second activation process. In this case, the control unit 240 may be configured to execute the first activation process in response to the detection of the activation instruction frame, and execute the second activation process when it is determined that the detection signal sequence and the unique signal sequence match.

<Modified Example>

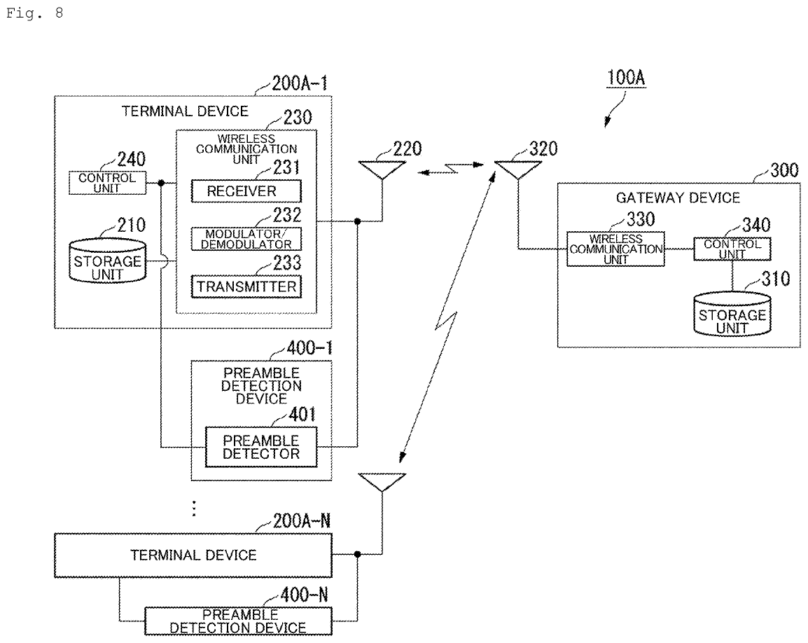

FIG. 8 is a diagram showing a first modified example of the wireless communication system 100 of the embodiment. A wireless communication system 100A of the modified example shown in FIG. 8 is different from the wireless communication system 100 of the embodiment in that a terminal device 200A is provided in place of the terminal device 200 and a preamble detection device 400 is further provided. The terminal device 200A is different from the terminal device 200 of the embodiment in that the preamble detector 234 is not provided. Since other configurations are the same as those of the wireless communication system 100 of the embodiment, those similar configurations are denoted by the same reference numerals as in FIG. 1 and the description thereof will be omitted. In the wireless communication system 100A of the modified example, a set of some terminal devices 200A-n and some preamble detection devices 400-n (n is an integer from 1 to N) may be replaced with the terminal device 200 of the embodiment.

The preamble detection device 400 includes a preamble detector 401 having the same function as the preamble detector 234. The preamble detector 401 receives the reception signal of the radio antenna 220, detects the preamble signal at the intermittent operation interval set by the control unit 240, and notifies the control unit 240 of the detection result. According to the wireless communication system 100A of the first modified example configured in this way, it is possible to obtain the same effect as the wireless communication system 100 of the embodiment without significantly changing the hardware configuration of the existing terminal device.

In the wireless communication system 100A of the modified example, some or all of the preamble detection devices 400-1 to N may be integrated into one preamble detection device 400. In this case, the preamble detection device 400 may be configured to include a preamble detector 401 for each terminal device 200A connected to the subject device. The preamble detection device 400 may not acquire a received signal from the radio antenna 220 of the terminal device 200A, but may have a radio antenna similar to that of the terminal device 200A and receive a wireless signal on the same channel as the terminal device 200A connected to the subject device.

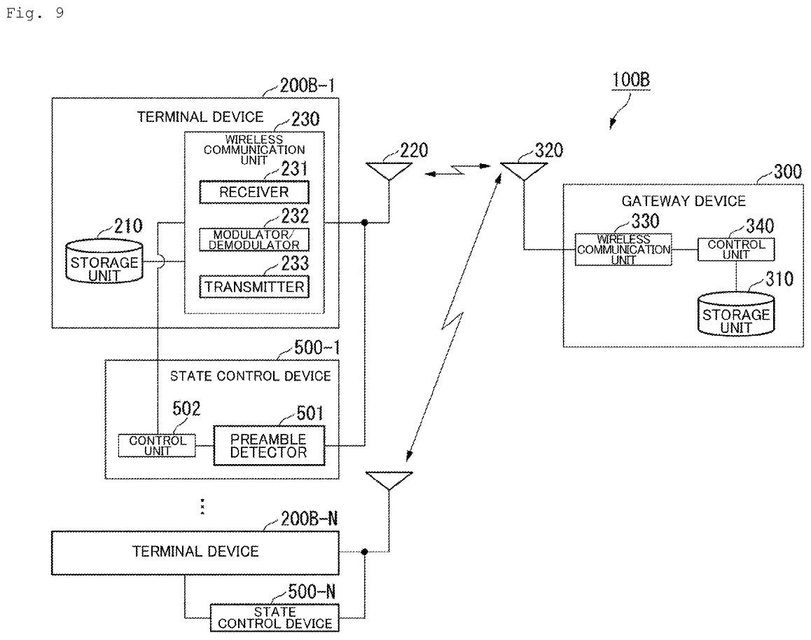

FIG. 9 is a diagram showing a second modified example of the wireless communication system 100 of the embodiment. A wireless communication system 100B of the modified example shown in FIG. 9 is different from the wireless communication system 100 of the embodiment in that the terminal device 200B is provided in place of the terminal device 200 and a state control device 500 is further provided. The terminal device 200B is different from the terminal device 200 of the embodiment in that the preamble detector 234 is not provided and the control unit 240 is not provided. Since other configurations are the same as those of the wireless communication system 100 of the embodiment, those similar configurations are denoted by the same reference numerals as in FIG. 1 and the description thereof will be omitted. In the wireless communication system 100B of the modified example, a set of some terminal devices 200B-n and some state control devices 500-n (n is an integer from 1 to N) may be replaced with the terminal device 200 of the embodiment or the set of the terminal device 200A and the preamble detection device 400 of the first modified example.

The state control device 500 includes a preamble detector 501 having the same function as the preamble detector 234, and a control unit 502 having the same function as the control unit 240. The preamble detector 501 receives the reception signal of the radio antenna 220, detects the preamble signal at the intermittent operation interval set by the control unit 502, and notifies the control unit 502 of the detection result. The control unit 502 controls the operating state of the terminal device 200B by performing the same processing as the control unit 240. According to the wireless communication system 100B of the second modified example configured in this way, the same effect as that of the wireless communication system 100 of the embodiment can be obtained while using the existing terminal device.

In the wireless communication system 100B of the modified example, some or all of the state control devices 500-1 to N may be integrated into one state control device 500. In this case, the state control device 500 may be configured to include a preamble detector 501 and a control unit 502 for each terminal device 200B connected to the subject device. The state control device 500 may not acquire the received signal from the radio antenna 220 of the terminal device 200B, but may have a radio antenna similar to that of the terminal device 200B and receive the wireless signal on the same channel as the terminal device 200B connected to the subject device.

Although the embodiments of the present invention have been described in detail with reference to the drawings, specific configurations are not limited to these embodiments, and designs and the like within a range that does not deviating from the gist of the present invention are also included.

### INDUSTRIAL APPLICABILITY

The present invention is applicable to a wireless communication system including a terminal device that performs an intermittent operation.

### REFERENCE SIGNS LIST

100 Wireless communication system
200 Terminal device
210 Storage unit
220 Radio antenna
230 Wireless communication unit
231 Transmitter
232 Modulator/demodulator
233 Receiver
234 Preamble detector
240 Control unit
300 Gateway device
310 Storage unit
320 Radio antenna
330 Wireless communication unit
400 Preamble detection device
401 Preamble detector
500 State control device
501 Preamble detector
502 Control unit

1. A wireless communication system comprising:
one or more terminal devices configured to transition between a first state in which a wireless signal can be intermittently detected and a second state in which a wireless signal can be transmitted and received; and
a gateway device configured to transmit an instruction frame instructing the one or more terminal devices to transition to the second state at a predetermined transmission interval, wherein
each of the one or more terminal devices includes:
an instruction frame detector configured to detect the instruction frame at a detection interval longer than an interval at which the gateway device transmits the instruction frame;
a preamble signal detector configured to detect a preamble signal at a predetermined time interval and a predetermined frequency channel when the instruction frame is detected; and
a control unit, including one or more processors, configured to cause a subject terminal device to transition from the first state to the second state based on a detection result of one or more preamble signals in one or more frequency channels.

2. The wireless communication system according to claim 1, wherein when a detection signal sequence based on the preamble signal detected for one or more frequency channels matches a predetermined signal sequence unique to the subject terminal device, the control unit is configured to cause the subject terminal device to transition from the first state to the second state.

3. The wireless communication system according to claim 2, wherein the control unit is configured to determine the detection signal sequence before the instruction frame is received or demodulated, and to determine whether or not to receive the instruction frame based on the determination result.

4. The wireless communication system according to claim 3, further comprising:
a frame receiver configured to receive and demodulate an instruction frame detected during one detection interval when a detection signal sequence detected in the one detection interval matches the unique signal sequence and to not receive or demodulate the instruction frame when the detection signal sequence does not match the unique signal sequence.

5. The wireless communication system according to claim 2, wherein
the unique signal sequence is generated based on setting information regarding generation, transmission, reception, or detection of frames by the terminal device, and
the preamble signal transmitted in a predetermined order of frequency channels is generated so that a signal sequence arranged in the transmission order becomes the unique signal sequence.

6. The wireless communication system according to claim 1, wherein
when the instruction frame is detected, the preamble signal detector is configured to attempt to detect the preamble signal for a predetermined channel in a predetermined order.

7. A wireless communication method in a wireless communication system comprising:
one or more terminal devices configured to transition between a first state in which a wireless signal can be intermittently detected and a second state in which a wireless signal can be transmitted and received; and
a gateway device configured to transmit an instruction frame instructing the one or more terminal devices to transition to the second state at a predetermined transmission interval, wherein
each of the one or more terminal devices executes:
detecting the instruction frame at a detection interval longer than an interval at which the gateway device transmits the instruction frame;
detecting a preamble signal at a predetermined time interval and a predetermined frequency channel when the instruction frame is detected; and
causing a subject terminal device to transition from the first state to the second state based on a detection result of one or more preamble signals in one or more frequency channels.

8. A terminal device in a wireless communication system comprising:
one or more terminal devices configured to transition between a first state in which a wireless signal can be intermittently detected and a second state in which a wireless signal can be transmitted and received; and
a gateway device configured to transmit an instruction frame instructing the one or more terminal devices to transition to the second state at a predetermined transmission interval, each of the terminal devices comprising:
an instruction frame detector configured to detect the instruction frame at a detection interval longer than an interval at which the gateway device transmits the instruction frame;
a preamble signal detector configured to detect a preamble signal at a predetermined time interval and a predetermined frequency channel when the instruction frame is detected; and
a control unit, including one or more processors, configured to cause a subject terminal device to transition from the first state to the second state based on a detection result of one or more preamble signals in one or more frequency channels.

9. The wireless communication method according to claim 7, comprising:
when a detection signal sequence based on the preamble signal detected for one or more frequency channels matches a predetermined signal sequence unique to the subject terminal device, causing the subject terminal device to transition from the first state to the second state.

10. The wireless communication method according to claim 9, comprising:
determining the detection signal sequence before the instruction frame is received or demodulated, and determining whether or not to receive the instruction frame based on the determination result.

11. The wireless communication method according to claim 10, wherein:
a frame receiver is configured to receive and demodulate an instruction frame detected during one detection interval when a detection signal sequence detected in the one detection interval matches the unique signal sequence and to not receive or demodulate the instruction frame when the detection signal sequence does not match the unique signal sequence.

12. The wireless communication method according to claim 9, wherein
the unique signal sequence is generated based on setting information regarding generation, transmission, reception, or detection of frames by the terminal device, and
the preamble signal transmitted in a predetermined order of frequency channels is generated so that a signal sequence arranged in the transmission order becomes the unique signal sequence.

13. The wireless communication method according to claim 7, comprising:
when the instruction frame is detected, attempting to detect the preamble signal for a predetermined channel in a predetermined order.

14. The terminal device in the wireless communication system according to claim 8, wherein
when a detection signal sequence based on the preamble signal detected for one or more frequency channels matches a predetermined signal sequence unique to the subject terminal device, the control unit is configured to cause the subject terminal device to transition from the first state to the second state.

15. The terminal device in the wireless communication system according to claim 14, wherein
the control unit is configured to determine the detection signal sequence before the instruction frame is received or demodulated, and to determine whether or not to receive the instruction frame based on the determination result.

16. The terminal device in the wireless communication system according to claim 15, further comprising:
a frame receiver configured to receive and demodulate an instruction frame detected during one detection interval when a detection signal sequence detected in the one detection interval matches the unique signal sequence and to not receive or demodulate the instruction frame when the detection signal sequence does not match the unique signal sequence.

17. The terminal device in the wireless communication system according to claim 14, wherein
the unique signal sequence is generated based on setting information regarding generation, transmission, reception, or detection of frames by the terminal device, and
the preamble signal transmitted in a predetermined order of frequency channels is generated so that a signal sequence arranged in the transmission order becomes the unique signal sequence.

18. The terminal device in the wireless communication system according to claim 8, wherein
when the instruction frame is detected, the preamble signal detector is configured to attempt to detect the preamble signal for a predetermined channel in a predetermined order.
